(19) United States
(12) Patent Application Publication
(10) Pub. No.: US 2008/0126432 A1
(43) Pub. Date: May 29, 2008

(54) METHOD AND APPARATUS FOR SHORTENING FILE NAME

(75) Inventors: Young-joon AHN, Suwon-si (KR); Hyun-Seok Choi, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/779,995

(22) Filed: Jul. 19, 2007

(30) Foreign Application Priority Data
Nov. 24, 2006 (KR) 2006-117098

(51) Int. Cl. G06F 12/00

(52) U.S. Cl. 707/200

(57) ABSTRACT

A method and an apparatus of shortening a file name, where the method includes interpreting a file name to separate at least one word from the file name and separating at least one basic word from among the at least one separated word, filtering the at least one word separated from the file name using a deletion word list that includes words to be deleted with respect to the basic word and a reservation word list that includes words to be stored with respect to the basic word, and generating a shortened file name using one or more words that remains after filtering, wherein the basic word is used in the file name and is set in advance. A user does not need to reset the file name for the file name to be managed and a file can be easily identified thereby.

### CROSS-REFERENCE TO RELATED APPLICATIONS

This application claims the benefit of Korean Application No. 2006-117098, filed Nov. 24, 2006 in the Korean Intellectual Property Office, the disclosure of which is incorporated herein by reference.

### BACKGROUND OF THE INVENTION

1. Field of the Invention

The present invention relates to a method and apparatus of shortening a file name, and more particularly, to a method and apparatus of shortening a file name to enable a user to easily recognize a file name when a file having a long file name is indicated or displayed.

2. Description of the Related Art

When displaying a long file name of a file on a large display screen, such as a monitor of a personal computer (PC), the long file name may be easily displayed entirely or partially. In the latter case, the entire file name may be displayed on the display screen when a user places a mouse on the file name to display the entire file name using a tooltip function. However, in a mobile device having a small display screen, such a long file name cannot be displayed entirely on the small display screen at once. In this case, as illustrated in FIG. 1, the long file name is scrolled from right to left so as to be displayed on the small display screen in its entirety.

FIG. 1 is a diagram illustrating a display of a typical long file name on an output screen. Referring to FIG. 1, a file name, for example, “Marrying.The.Mafia.2.2005.DVDRip.XVID.AC3.5.1 CH.CD1.CaYEnne.avi” of a moving picture file (or a video file) is illustrated. The file name of the moving picture file 110 includes a title (Marrying.The.Mafia.2) 111, a year of the file introduction or production (2005) 112, a source of the moving picture (DVDRip) 113, a codec of a moving picture file (Xvid) 114, an audio codec (AC3) 115, a channel (5.1CH) 116, a volume number of file (CD1) 117, a release group (CaYEnne) 118, and a file extension (avi) 119.

When such a long file name 110 is displayed on a small display screen 120 that is a small display screen, only a part of the long file name 110 is displayed, and the rest is represented by “ . . . ”, while the long file name is scrolled across the small display screen 120. If the long file name 110 is displayed on the screen 120 as shown in FIG. 1, a user cannot immediately recognize and distinguish the file with the long file name. For example, if a plurality of files has the same title, and a user wants to know the specific distinguishing number or the volume number of the files, the user has to wait until distinguishing information, such as “CD1”, is scrolled and indicated or displayed on the small display screen 120 as shown in FIG. 1. In addition, scrolling of the various long file names simultaneously across the small display screen 120 increases an output load of a mobile device and cause a display screen of such a mobile device to become more complex.

### SUMMARY OF THE INVENTION

The present invention provides a method and apparatus of shortening a file name for a user to easily recognize and distinguish a file name when a file having a long file name is indicated or displayed.

According to an aspect of the present invention, a method of shortening a file name includes: interpreting a file name to separate at least one word from the file name and separating at least one basic word from among the at least one separated word; filtering the at least one word separated from the file name, using a deletion word list that includes words to be deleted with respect to the basic word and a reservation word list that includes words to be stored with respect to the basic word; and generating a shortened file name using one or more words that remain after the filtering operation, wherein the basic word is used in the file name and is set in advance.

According to another aspect of the present invention, there is provided an apparatus of shortening a file name including: a file name interpreting unit which interprets a file name to separate at least one word from the file name and separates at least one basic word from the at least one separated word; a storing unit which stores a deletion word list that includes words to be deleted with respect to the basic word and a reservation word list that includes words to be stored with respect to the basic word; and a file name generating unit to filter the at least one word separated from the file name using the deletion word list that includes words to be deleted and the reservation word list that includes words to be stored, respectively, and then to generate a shortened file name using one or more words that remain after the filtering operation, wherein the basic word is used in the file name and is set in advance.

According to another aspect of the present invention, a computer readable medium having embodied thereon a computer program for a computer to perform a method of shortening a file name, the method including: interpreting a file name to separate at least one word from the file name and separating at least one basic word from among the at least one separated word; filtering the at least one word separated from the file name using a deletion word list that includes words to be deleted with respect to the basic word and a reservation word list that includes words to be stored with respect to the basic word; and generating a shortened file name using one or more words that remain after the filtering operation, wherein the basic word is used in the file name and is set in advance.

According to another aspect of the present invention, a method of forming a modified name of a digital file includes obtaining a name of a digital file having a plurality of file indicators of the digital file, extracting at least one of the plurality of file indicators as a flag indicator of the digital file, determining at least one of the plurality of file indicators that is identical to one or more list indicators, wherein one or more lists correspond to the extracted flag indicator, at least one of deleting or retaining the at least one of the plurality of file indicators that is identical to the list indicators to obtain one or more remaining indicators, forming a modified name of the digital file using one or more of the remaining indicators.

According to another aspect of the present invention, an apparatus to form a modified name of a digital file includes a storage to store one or more lists containing one or more list indicators, a controller to obtain a name of a digital file having a plurality of file indicators of the digital file, to extract at least one of the plurality of file indicators as a flag indicator of the digital file, to determine at least one of the plurality of file indicators that is identical to one or more list indicators, wherein the one or more lists correspond to the extracted flag indicator, to at least one of delete or retain the at least one of the plurality of file indicators that is identical to the list indicators to obtain one or more remaining indicators, and to form a modified name of the digital file using one or more of the remaining indicators.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating a display of a typical long file name on an output screen;

FIG. 2 is a block diagram of an apparatus of shortening a file name according to an example embodiment of the present invention;

FIG. 3 illustrates a word list used in shortening a file name according to an example embodiment of the present invention;

FIG. 4 illustrates a word list used in shortening a file name, which is in the form of a text file, which can be corrected or modified by a user;

FIG. 5 is a diagram illustrating how a file name appears on a display screen according to an example embodiment of the present invention; and

FIG. 6 is a flow chart illustrating a method of shortening a file name according to an example embodiment of the present invention.

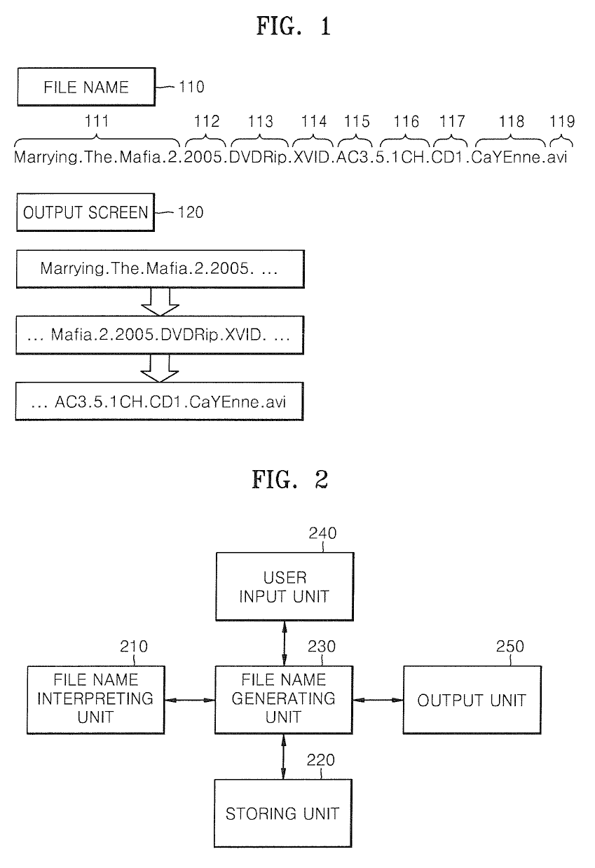

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

FIG. 2 is a block diagram of an apparatus of shortening a file name according to an example embodiment of the present invention. Referring to FIG. 2, the apparatus includes a file name interpreting unit 210, a storing unit 220, a file name generating unit 230, a user input unit 240, and an output unit 250.

The file name interpreting unit 210 interprets (or examines) a file name and separates (or extracts) at least one word included in the file name, and separates (or extracts) at least one basic word from the at least one word that is separated (or extracted) from the file name. When the at least one word is separated from the file name, a predetermined symbol (or punctuation) can be used to distinguish the separated word. For example, the symbol used to distinguish the word from the file name may be “.” or “-” used in codes forming the file name, or a code indicating “.”, “-”, or a blank space. Since a file extension is usually placed next to the symbol (that looks like a period) and placed at the end of the file name, the file extension is excluded from being filtered.

In various example embodiments, a basic word is defined as one of the most-used words in a file name, though not required. For example, if a file name represents a moving picture file (a video file), then words which are usually included in the file name, such as the file playing time, a moving picture codec, an audio codec, an audio channel, a release group (or an individual), or an original source of the file, can be designated as the basic word. Such basic words can be set in advance and/or can be changed by a user by way of a signal inputted by the user. In other example embodiments, the basic word may be a selectable word, a predetermined word, or may relate to a particular digital media file.

The file name interpreting unit 210 determines whether a shortened file name needs to be produced, and then informs the file name generating unit 230 of the need to produce the shortened file name. By way of example, when a file name is to be output through the output unit 250, the file name interpreting unit 210 estimates the length of a file name that will fit a display screen of the output unit 250 at once. Then, if the file name cannot be displayed on the display screen at once, the file name interpreting unit 210 determines that the shortened file name should be generated from the file name.

The file name interpreting unit 210 can estimate the length of the file name to be output to the display screen using a length calculation function provided by an operating system (OS) that controls the general file name shortening operation of the apparatus. In addition, if the file name interpreting unit 210 is to output the file name using an image font of an application program and having a particular width, then the file name interpreting unit 210 can estimate the overall length of the file name to be output to the display screen of the output unit 250 using the width of the image font. In other words, the overall length of the file name can be determined by adding the width of each “letter” of the image font that constitutes the file name. It should be understood that the length of the shorted file name may also be extracted by the above operation.

The storing unit 220 stores a deletion word list that includes words to be deleted corresponding to the basic word, and a reservation word list (or a retain word list) that includes words to be stored (or kept) corresponding to the basic word. In the storing unit 220, both lists may be distinguished by (or be based on) one or more basic words. In addition, the storing unit 220 may be organized in a database format in order for both lists to be searched according to the basic words. At least one of the deletion word list and the reservation word list can exist (or be stored) in the storing unit 220.

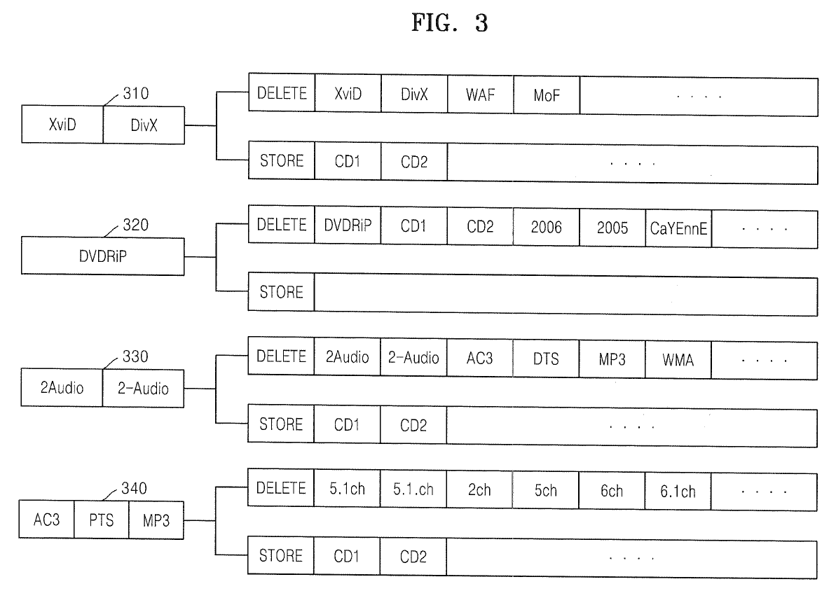

The relationship between both lists with respect to the basic words will be illustrated later with reference to FIG. 3. Both word lists may be set (or determined) in advance and/or may be generated or changed by a user by way of a signal inputted by the user.

The file name generating unit 230 filters the at least one word which is separated (or extracted) using the deletion word list or lists and the reservation word list or lists, respectively, and then generates a shortened file name using one or more of the filtered words that remain. In other words, the file name generating unit 230 deletes the words included in the deletion word list and stores (or retains) the words included in the reservation word list with respect to the at least one word separated from the file name to perform filtering of the words, and then combines the remaining words after the filtering operation to generate a shortened file name.

The file name generating unit 230 uses various methods to efficiently generate the shortened file name. According to an example embodiment of the present invention, the file name generating unit 230 generates a first filtering list including words that are included more than once in the deletion word list and a second filtering list including words that are included more than once in the reservation word list. That is, the file name generating unit 230 generates the first filtering list, which corresponds to a union of the words included in the deletion word list, and the second filtering list, which corresponds to a union of the words included in the reservation word list. Both lists may correspond to at least one basic word included in the file name.

Next, the file name generating unit 230 deletes the word included in the first filtering list from the at least one word separated from the file name. If the word included in the second filtering list exists among the deleted words, deletion of the word included in the second filtering list is cancelled. The file name generating unit 230 then combines the words remaining after the filtering operation as described above and generates a shortened file name. In this example embodiment, the words in the second filtering list supersede the list in the first filtering list, though not required.

According to another example embodiment of the present invention, rather than having a separate first and a second filtering lists, both lists may be combined to create a third list to be used in the filtering of the separated words. Accordingly, once the file name generating unit 230 generates the first filtering list and the second filtering list, as described above, the file name generating unit 230 removes the words included in the second filtering list from the first filtering list to generate a third filtering list, and filters out at least one word from the file name using the words included in the third filtering list. In yet another example embodiment of the present invention, a vice versa operation is possible, whereby the file name generating unit 230 removes the words included in the first filtering list from the second filtering list to generate a fourth filtering list, and retains only the words included in the fourth filtering list, while deleting the rest from the long file name.

The user input unit 240 receives a signal inputted by a user and transmits the signal to the file name generating unit 230. Accordingly, the deletion word lists and the reservation word lists to filter the file name, which are stored in the storing unit 220, can be generated or changed.

The output unit 250 outputs a file name via a display screen. The output unit 250 can selectively output the original file name or the shortened file name according to the user's selection by way of a signal inputted by the user.

According to an example embodiment of the present invention, the apparatus of shortening a file name as shown in FIG. 2, may be included in a portable multimedia player (PMP) and other mobile devices and notebook PCs, and can be used to shorten the long file name such as a moving picture file (or a video file) or an audio file. In various aspects, the moving picture file (or the video file) and the audio file are digital files.

Turning now to FIG. 3, an example word list used in shortening a file name according to an example embodiment of the present invention is illustrated. When a basic word is “Xvid” or “DivX” 310 to indicate a moving picture (or a video) codec, the deletion word list includes words, such as “Xvid”, “DivX” for the moving picture codec and a release group “WAF”, “MoF”, and the reservation word list includes words, such as “CD1”, and “CD2” of the order of files (or the volume number of files) having same title. When a basic word is “DVDRip” 320 to indicate information of being extracted from a DVD among the original source of the moving picture, the deletion word list includes words such as “DVDRip”, “CD1”, “CD2”, “2006”, “2005”, and “CaYEnne”, and the reservation word list may not exist, or may be empty. In other aspects, other words may be included in the deletion word list or the reservation word list corresponding to the above noted basic words.

In another example embodiment, when a basic word is “2Audio” or “2-Audio”, which indicates that the moving picture file can be played in two languages, is identified as a basic word, the deletion word list that is related to the basic word includes words such as “2Audio”, “2-Audio”, “AC3”, “DTS”, “MP3”, and “WMA”, and the reservation word list includes words such as “CD1” and “CD2”. When the basic word is “AC3”, “DTS”, or “MP3” indicating an audio codec, the deletion word list includes words such as “5.1Ch”, “5.1.Ch”, “2Ch”, “5Ch”, “6Ch”, and “6.1Ch”, and the reservation word list includes words such as “CD1” and “CD2”, though not required.

The deletion word list may include at least one word indicating a codec of a moving picture file, an audio codec, a source of the file, and a release group (or individual) to identify a person who or entity that distributes the file. The reservation word list may include a word indicating the order (or the volume number) of the files having the same title. The word list used in shortening the file name illustrated in FIG. 3 is only by way of example. Accordingly, various word lists may be formed in various forms.

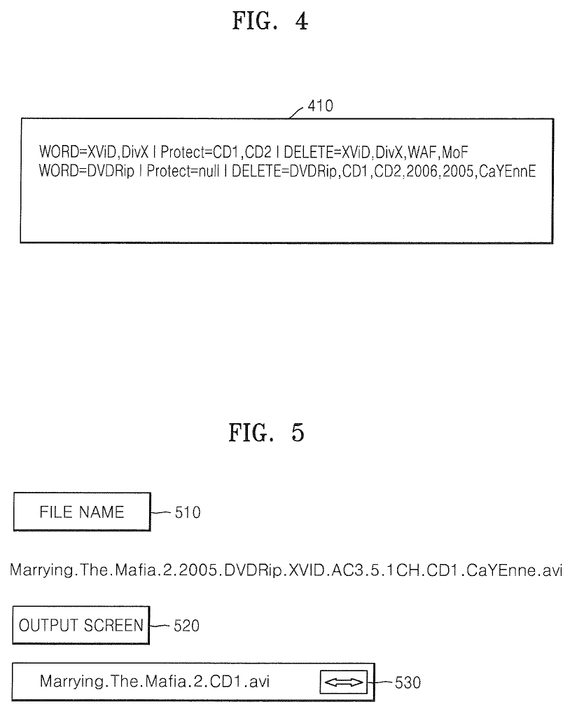

FIG. 4 illustrates word lists used in shortening a file name, which is in the form of a text file which can be corrected or modified by a user. As shown in FIG. 4, one example of the word lists 410 includes; WORD=XViD,DivX|Protect=CD1,CD2|DELETE=XVid,DivX,WAF,MoF. Another example of the word lists 410 includes; WORD=DVDRip|Protect=nul1|DELETE=DVDRip,CD1,CD2,2006,2005,CaYEnnE. Since a user can edit or correct an initialization (INI) file in an application program, the word lists of the file name can be generated or corrected to generate a file name that includes information that is of interest to the user from the long file name. For example, if the text file is coded as illustrated in FIG. 4, then the apparatus of shortening a file name interprets the text file to thereby generate or change the content of the deletion word list and the reservation word list, respectively, which are related to the basic word stored in the storing unit 220.

FIG. 5 is a diagram illustrating how a file name appears on an output screen according to an example embodiment of the present invention.

By way of example, a process of generating a shortened file name from a moving picture file having a long file name 510 of, for example, “Marrying.The.Mafia.2.2005.DVDRip.XVID.AC3.5.1CH.CD1.CaYEnne.avi” using the word list illustrated in FIG. 3 is as follows. The words formed of the file name can be separated using “.”, “-”, or a code indicating the “.”, the “-”, and/or a blank space. First, the file name interpreting unit 210 separates the basic words from the file name. Referring to FIG. 3, the basic words for this example are “DVDRip”, “Xvid”, and “AC3”. The file name generating unit 230 calls from the storing unit 220 the at least one deletion word list which is related to the basic words, and generates the first filtering list. The at least one deletion word list corresponds to a union (or a collection) of the deletion word list. In this example embodiment, the first filtering list includes words “Xvid”, “DivX”, “WAF”, “MoF”, “DVDRip”, “CD1”, “CD2”, “2006”, “2005”, “CaYEnne” “5.1Ch”, “5.1.Ch”, “2Ch”, “5Ch”, “6Ch”, and “6.1Ch”. In addition, the file name generating unit 230 calls the at least one reservation word list which is related to the basic words, and generates the second filtering list. The at least one reservation word list corresponds to a union (or a collection) of the reservation word list. In this example embodiment, the second filtering list includes words “CD1” and “CD2”.

The file name generating unit 230 deletes the word that is included in the first filtering list from at least one word separated from the file name. Then, the words which are not deleted and remain are “Marry”, “The”, “Mafia”, “2”, and “avi”. If there are words which are included in the second filtering list among the deleted words, such as “CD1” that is included in the second filtering list, deletion is cancelled for that word. Accordingly, the ultimately remaining words are “Marry”, “The”, “Mafia”, “2”, “CD1”, and “avi”. The file name generating unit 230 combines the words that remain after the filtering operation described above, to generate a shortened file name.

In another example embodiment, the file name generating unit 230 first removes the words included in the second filtering list from the first filtering list to generate the third filtering list. The third filtering list includes “Xvid”, “DivX”, “WAF”, “MoF”, “DVDRip”, “2006”, “2005”, “CaYEnne” “5.1Ch”, “5.1.Ch”, “2Ch”, “5Ch”, “6Ch”, and “6.1Ch”. When the at least one word separated from the file name is filtered using the words included in the third filtering list, the ultimately remaining words are “Marry”, “The”, “Mafia”, “2”, “CD1”, and “avi”. Accordingly, the shortened file name can be formed using the ultimately remaining words.

Therefore, according to an example embodiment of the present invention, the file name “Marrying The Mafia 2 CD1.avi” can be generated and displayed on an output screen 520 as illustrated in FIG. 5. Optionally, a long file name can be provided to the display screen in response to a user inputting a request to display an original file name, for example, by way of an extension button 530 selectively displayed.

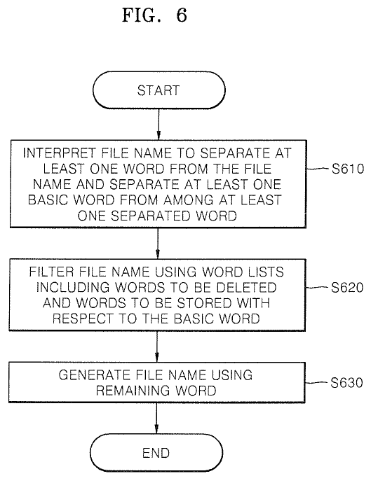

FIG. 6 is a flow chart illustrating a method of shortening a file name according to an example embodiment of the present invention. First, it is determined whether the file name needs to be shortened prior to operation 610. If it is determined that the file name needs to be shortened, operation 610 is performed. In operation 610, a file name is interpreted (or examined) in order to separate at least one word from the file name, and at least one basic word is separated (or identified) from among the at least one separated word.

In operation 620, the at least one word separated from the file name is filtered using the at least one deletion word list and the at least one reservation word list, respectively, with respect to the basic word. Both lists may be maintained according to the corresponding basic words. In addition, both lists may be generated or changed based on a user, by way of a signal inputted by the user.

Methods of performing operation 620 includes generating the first filtering list with respect to at least one basic word; generating the second filtering list with respect to at least one basic word; deleting the word included in the first filtering list from the at least one word separated from the file name; and when the word included in the second filtering list exists among the deleted words, canceling the deletion of the word. Alternatively, operation 620 may include generating the third filtering list that includes words from the second filtering list that are removed from the first filtering list; and deleting the word included in the third filtering list from the at least one word separated from the file name. In operation 630, a shortened file name is generated and outputted using the word that remains after the filtering is performed. In this case, the original file name or the shortened file name is selectively outputted according to a signal inputted by a user.

The invention can be embodied as computer readable codes on a computer readable recording medium. Also, codes and code segments to accomplish the above program can be easily construed by programmers skilled in the art to which the present invention pertains. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and flash memory. The computer readable recording medium can also be distributed over network coupled computer systems so that the computer readable code is stored and executed in a distributed fashion.

As described above, in the example embodiments of the present invention, even though a file name is long, a shortened file name that includes information desired by a user can be generated. Accordingly, the user does not need to reset the file name for the file name to be managed, and a shorter file name can be easily identified by the user.

In addition, the original file name or the shortened file name is selectively outputted according to a signal inputted by a user so that the file name desired by the user can be outputted.

Although discussed in terms of words of a file name, in various aspects, words may be substituted by names, format, expander, volume, type, codes, or similar items. In various aspects, the words of the file name are of the MPEG standard and/or other digital audio and/or video standard. In various aspects, the mobile devices include a digital media player, a cell phone, a mini Dvix player, a microcomputer, a personal digital assistants (PDA's), a digital multimedia broadcast (DMB) player, and similar devices.

In various example embodiments, the basic word corresponds to one or more words of the file name. Accordingly, use of a particular word may correspond to one or more default words for deletion and/or reservation. Accordingly, a user may simply input a basic word to generate the deletion word list and/or a reservation word list that correspond to the basic word, in which case the relevant word list is populated by corresponding predetermined words.

Various components of the file name shortening apparatus, as shown in FIG. 2, such as the file name interpreting unit 210 and/or the file name generating unit 230 can be integrated into a single control unit, or alternatively, can be implemented in software or hardware, such as, for example, a field programmable gate array (FPGA), or an application specific integrated circuit (ASIC). As such, it is intended that the processes described herein be broadly interpreted as being equivalently performed by software, hardware, or a combination thereof. As previously discussed, software modules can be written, via a variety of software languages, including C, C++, Java, Visual Basic, and many others. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Instructions of the software routines or modules may also be loaded or transported into the wireless cards or any computing devices on the wireless network in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the basic word may be a selectable word, a predetermined word, or may relate to a particular digital media file. Also, the overall length of the file name can be determined by adding the width of each “letter” of the image font that constitutes the file name. It should be understood that the length of the shorted file name may also be extracted by the operations.

Also, rather than having a separate first and a second filtering lists, both lists may be combined to create a third list to be used in the filtering of the separated words. the file name generating unit 230 removes the words included in the first filtering list from the second filtering list to generate a fourth filtering list, and retains only the words included in the fourth filtering list, while deleting the rest from the long file name. Also, the deletion word list and the reservation word list may not exist, or may be empty. In other aspects, other words may be included in the deletion word list or the reservation word list corresponding to the basic words.

What is claimed is:

1. A method of shortening a file name, comprising:
interpreting a file name to separate at least one word from the file name and separating at least one basic word from among the at least one separated word;
filtering the at least one word separated from the file name, using a deletion word list that includes words to be deleted with respect to the basic word, and a reservation word list that includes words to be stored with respect to the basic word; and
generating a shortened file name using one or more words that remain after the filtering operation,
wherein the basic word is used in the file name and is set in advance.

2. The method of claim 1, wherein the separating of the at least one word from the file name includes using a symbol to distinguish the at least one word from the file name.

3. The method of claim 1, wherein the deletion word list and the reservation word list are each distinguished by each of the basic word.

4. The method of claim 1, wherein the filtering of the at least one word comprises:
generating a first filtering list including words that are included more than once in the deletion word list;
generating a second filtering list including words that are included more than once in the reservation word;
deleting the words included in the first filtering list from the at least one word separated from the file name; and
if the words included in the second filtering list are included among the deleted words, canceling the deletion of the words.

5. The method of claim 1, wherein the filtering of the at least one word comprises:
generating a first filtering list including words that are included more than once in the deletion word list;
generating a second filtering list including words that are included more than once in the reservation word list;
generating a third filtering list in which the words included in the second filtering list are removed from the first filtering list; and
deleting one or more words included in the third filtering list from the at least one word separated from the file name.

6. The method of claim 1, wherein the deletion word list comprises at least one of a word indicating a codec of a moving picture file, a word indicating an audio codec, a word indicating a source of the file, and a release group to identify a distributor of the file.

7. The method of claim 1, wherein the reservation word list comprises a word indicating an order of the files having the same title.

8. The method of claim 1, further comprising determining whether the file name needs to be shortened.

9. The method of claim 1, further comprising selectively outputting an original file name or a shortened file name according to a signal inputted by a user.

10. The method of claim 1, further comprising generating or changing at least one of the deletion word list and the reservation word list according to a signal inputted by a user.

11. An apparatus to shorten a file name, comprising:
a file name interpreting unit to interpret a file name to separate at least one word from the file name and to separate at least one basic word from the at least one separated word;
a storing unit to store a deletion word list that includes words to be deleted with respect to the basic word, and a reservation word list that includes words to be stored with respect to the basic word; and
a file name generating unit to filter the at least one word separated from the file name using the deletion word list and the reservation word list, respectively, and then to generate a shortened file name using one or more words that remain after the filtering operation, wherein the basic word is used in the file name and is set in advance.

12. The apparatus of claim 11, wherein the file name interpreting unit uses a symbol to distinguish the at least one word from the file name.

13. The apparatus of claim 11, wherein the deletion word list and the reservation word list are each distinguished by each of the basic word.

14. The apparatus of claim 11, wherein the file name generating unit generates a first filtering list that includes words that are included more than once in the deletion word list, generates a second filtering list including words that are included more than once in the reservation word list, deletes the words included in the first filtering list from the at least one word separated from the file name, and when the words included in the second filtering list exists among the deleted words, cancels the deletion of the words included in the second filtering list.

15. The apparatus of claim 11, wherein the file name generating unit generates a first filtering list including words that are included more than once in the deletion word list, generates a second filtering list including words that are included more than once in the reservation word list, generates a third filtering list in which the words included in the second filtering list are removed from the first filtering list and filters the at least one word separated from the file name using the word included in the third filtering list.

16. The apparatus of claim 11, wherein the deletion word list comprises at least one of a word indicating a codec of a moving picture file, a word indicating an audio codec, a word indicating a source of the file, and a release group to identify distributor of the file.

17. The apparatus of claim 11, wherein the reservation word list comprises a word indicating an order of the files having the same title.

18. The apparatus of claim 11, wherein the file name interpreting unit determines whether the file name needs to be shortened.

19. The apparatus of claim 11, further comprising an input unit which receives a signal inputted by a user and an output unit which outputs the generated file name, wherein the output unit selectively outputs an original file name or a shortened file name according to a signal inputted by a user.

20. The apparatus of claim 11, further comprising an input unit which receives a signal inputted by a user, and at least one of the deletion word list and the reservation word list that are generated or changed according to the signal inputted by the user.

21. A computer readable medium having embodied thereon a computer program for a computer to perform a method of shortening a file name, the method comprising:
interpreting a file name to separate at least one word from the file name and separating at least one basic word from among the at least one separated word;
filtering the at least one word separated from the file name using a deletion word list that includes words to be deleted with respect to the basic word and a reservation word list that includes words to be stored with respect to the basic word; and
generating a shortened file name using one or more words that remain after the filtering operation, wherein the basic word is used in the file name and is set in advance.

22. A method of forming a modified name of a digital file, comprising:
obtaining a name of a digital file having a plurality of file indicators of the digital file;
extracting at least one of the plurality of file indicators as a flag indicator of the digital file;
determining at least one of the plurality of file indicators that is identical to one or more list indicators, wherein one or more lists correspond to the extracted flag indicator;
at least one of deleting or retaining the at least one of the plurality of file indicators that is identical to the list indicators to obtain one or more remaining indicators; and
forming a modified name of the digital file using one or more of the remaining indicators.

23. The method of claim 22, wherein the one or more lists includes a delete list and a retain list, and the at least one of deleting or retaining of the at least one of the plurality of file indicators includes:
deleting the at least one of the plurality of file indicators that is identical to the list indicators in the delete list; and
retaining the at least one of the plurality of the file indicators that is identical to the list indicators in the retain list.

24. The method of claim 23, further comprising retaining the at least one of the plurality of file indicators that is identical to the list indicators in both the delete and the retain list.

25. The method of claim 22, wherein the various file indicators of the digital file includes one of a word, a video codec, an audio codec, a source, a distributor, and a volume number.

26. An apparatus to form a modified name of a digital file, comprising:
a storage to store one or more lists containing one or more list indicators;
a controller to obtain a name of a digital file having a plurality of file indicators of the digital file, to extract at least one of the plurality of file indicators as a flag indicator of the digital file, to determine at least one of the plurality of file indicators that is identical to one or more list indicators, wherein the one or more lists correspond to the extracted flag indicator, to at least one of delete or retain the at least one of the plurality of file indicators that is identical to the list indicators to obtain one or more remaining indicators, and to form a modified name of the digital file using one or more of the remaining indicators.

27. The apparatus of claim 26, wherein the one or more lists includes a delete list and a retain list, and the controller at least one of deletes or retains the at least one of the plurality of file indicators by:
deleting the at least one of the plurality of file indicators that is identical to the list indicators in the delete list; and
retaining the at least one of the plurality of the file indicators that is identical to the list indicators in the retain list.

28. The apparatus of claim 27, wherein the controller retains the at least one of the plurality of file indicators that is identical to the list indicators in both the delete and the retain list.

29. The apparatus of claim 26, wherein the various file indicators of the digital file includes one of a word, a video codec, an audio codec, a source, a distributor, and a volume number.
